(19) United States
(12) Patent Application Publication
(10) Pub. No.: US 2007/0116275 A1
(43) Pub. Date: May 24, 2007

(54) Method for the secure transmission of data, via networks, by exchange of encryption information, and corresponding encryption/decryption device

(75) Inventors: Moulay Fadili, Franconville (FR); Jerremy Zrihen, Jouy le Nouha (FR); Abdelkrim Moulehiawy, Paris (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/507,551

(22) Filed: Aug. 22, 2006

(30) Foreign Application Priority Data
Aug. 23, 2005 (EP) 05300687.0

(51) Int. Cl. H04L 9/00

(52) U.S. Cl. 380/46

(57) ABSTRACT

A device is dedicated to encrypting/decrypting data in a communication equipment able to exchange data with another data equipment of an equivalent type via at least one communication network entailing modulation/demodulation. This device comprises processing means adapted i) in the event of setting up a call between their called equipment and a calling equipment with a view to transmitting data to generate a first message to the calling equipment containing in a non-standard facilities field first data for determining a primary encryption key then to determine that primary encryption key as a function of the first data and ii) in the event of reception from the calling equipment of a second message containing (possibly in a field of the message) second data representative of its ability to encrypt data to be transmitted and then of encrypted data to decrypt the received encrypted data by means of the primary encryption key.

### CROSS-REFERENCE TO RELATED APPLICATIONS

This application is based on European Patent Application No. 05300687 filed Aug. 23, 2005, the disclosure of which is hereby incorporated by reference thereto in its entirety, and the priority of which is hereby claimed under 35 U.S.C. §119.

### BACKGROUND OF THE INVENTION

1. Field of the Invention

The invention relates to communication equipments of modem (modulator/demodulator) type, in particular using the V8 standard, and of facsimile (fax) type, in particular of G3, super G3 or G4 type, for transmitting data securely via at least one communication network (for example networks of IP (Internet Protocol), fax relay or packet type) entailing modulation/demodulation.

2. Description of the Prior Art

As the person skilled in the art is aware, the transmission of (digital) data between communication equipments via one or more IP network is not secure in the absence of a secure connection, for example a connection via a virtual private network using an IPSec (IP Security) type protocol (as defined by the specification RFC 2401). More precisely, a third party equipment connected to the IP network can access the data transmitted when in transit in the IP network.

This can in particular happen to data of facsimile type generated by a facsimile machine (fax) connected to an Internet media gateway or to a computer or by a communication terminal equipped with a soft fax over IP application, for example a server.

The drawback of prior art secure connections is that in the presence of data having to cross a plurality of IP (or packet or fax relay) networks it is necessary to encrypt the data specifically at the level of each network.

One object of the invention is therefore to remedy this drawback.

### SUMMARY OF THE INVENTION

To this end the invention proposes a method for secure transmission of data between first and second communication equipments via at least one communication network entailing modulation/demodulation, characterized in that, in the event of setting up a call between said equipments with a view to transmitting data, the method consists in:

transmitting from one of said equipments to the other a first message containing in a non-standard facilities field first data for determining a primary encryption key,

then determining said primary encryption key as a function of said first data in each equipment able to encrypt/decrypt data,

transmitting from the equipment that receives said first message to the equipment that sends said first message a second message containing second data representative of its ability to encrypt/decrypt data, said second data being encrypted by means of said primary encryption key,

then, on reception of said second message in the equipment that sent the first message, attempting to decrypt the second data by means of said primary encryption key to determine if it was encrypted by means of said primary encryption key and, if so, to conclude that the equipment that sent the second message is able to encrypt/decrypt data using said primary encryption key,

then, if and only if said equipments are both able to encrypt/decrypt data, activating encryption means in the equipment having data to be transmitted and activating decryption means in the other equipment that has to receive that data, the encryption means and the decryption means using said primary encryption key.

The method of the invention may have other features and in particular, separately or in combination:
the first data may be representative of a secondary key, in which case the primary encryption key is determined as a function of the secondary key;
   the first data may constitute the secondary key;
   the primary encryption key may be determined in the calling and called equipments by means of a selected function including a variable equal to the secondary key;
the second data (contained in the second message) may be encrypted by means of the primary encryption key;
   on reception of the second message, the aptitude data may be analysed in the receiver equipment to determine if it was encrypted using the primary encryption key;
      on reception of the second message the second data may be decrypted by means of the primary encryption key and it may be determined if the decryption result corresponds to encryption by means of the primary encryption key in order in the event of a match to decrypt subsequent encrypted data;
      the second data (contained in the second message) may constitute a selected series of symbols or a selected word encrypted by means of the primary encryption key;
the primary encryption key may be varied identically and substantially simultaneously in the calling equipment and the called equipment during the transmission of encrypted data;
in the presence of facsimile type data and of a calling equipment and a called equipment implementing a G3 type facsimile function, in the called equipment the first data may be integrated into an NSF type non-standard facilities field of a message containing fields DIS, CSI and NSF and in the calling equipment the second data may be integrated into a TCF type message or into a TCS type field of another message;
in the presence of a calling equipment and a called equipment of super G3 or G4 facsimile type and/or of modem type using the V8 standard, in the calling equipment the first data may instead be integrated into a non-standard facilities field of a Call Menu type message and in the called equipment the second data may instead be integrated into a Join Menu type message or into a field of another message.

The invention also proposes first and second encryption/decryption devices for communication equipments each adapted to implement the above method for the secure transmission of data.

The first device is characterized in that it comprises processing means adapted to:
i) in the event of setting up a call between the first equipment, which is then referred to as the called equipment, and the second equipment, which is then referred to as the calling equipment, with a view to transmission of data from the calling equipment to the called equipment, to generate a first message to the calling equipment containing in a non-standard facilities field first data for determining a primary encryption key, and then to determine that primary encryption key as a function of the first data, and
ii) in the event of reception from the calling equipment of a second message containing second data representative of its ability to encrypt data to be transmitted followed by the reception of encrypted data, activate decrypting means to decrypt the received encrypted data by means of the primary encryption key.

The second device is characterized in that comprises processing means adapted to:
i) in the event of setting up a call between the first equipment, which is then referred to as the calling equipment, and the second equipment, which is then referred to as the called equipment, with a view to transmission of data from the calling equipment to the called equipment, generate a first message to the called equipment containing in a non-standard facilities field first data for determining a primary encryption key, and
ii) in the event of reception from the called equipment of a second message containing second data representative of its ability to decrypt data, determine the primary encryption key as a function of the first data and then activate encrypting means to encrypt data to be transmitted to the called equipment by means of the primary encryption key.

The invention also proposes a communication equipment, for example a facsimile machine, a modem, a communication gateway, a facsimile server or a fixed or portable computer comprising an encryption/decryption device of the above type.

The invention is particularly well adapted, although not exclusively so, to the transmission of facsimile type data in IP (Internet Protocol), fax relay or packet type communication networks. The invention applies generally to any type of network in which the transmission of data entails modulation/demodulation.

Other features and advantages of the invention will emerge on reading the following detailed description and examining the appended drawings.

### BRIEF DESCRIPTION OF THE DRAWINGS

FIG. 1 is a diagram of an IP network coupled to, on the one hand, a G3 type facsimile server equipped with one embodiment of an encryption/decryption device of the invention and, on the other hand, a G3 type facsimile machine coupled to a facsimile machine and equipped with one embodiment of an encryption/decryption device of the invention.

FIG. 2 is a diagram of the main steps of transmission of facsimile type data in accordance with the ITU-T standard T.30.

FIG. 3 is a diagram of an IP network coupled to, on the one hand, a modem utilizing the V8 standard and equipped with one embodiment of an encryption/decryption device of the invention and, on the other hand, a super G3 type facsimile machine equipped with one embodiment of an encryption/decryption device of the invention.

### DETAILED DESCRIPTION OF THE PREFERRED EMBODIMENT

The appended drawings may not only constitute part of the description of the invention but also contribute to the definition of the invention, if necessary.

An object of the invention is to enable the secure transmission of data between two modem or facsimile (fax) type communication equipments via one or more IP, fax relay or packet type networks by end-to-end type encryption.

To this end, the invention consists in integrating an encryption/decryption device D into first and second communication equipments E1, E2 able to connect to a network RIP, for example of IP, fax relay or packet type, in order to transmit (digital) data securely.

The network RIP considered hereinafter by way of nonlimiting example is an IP network.

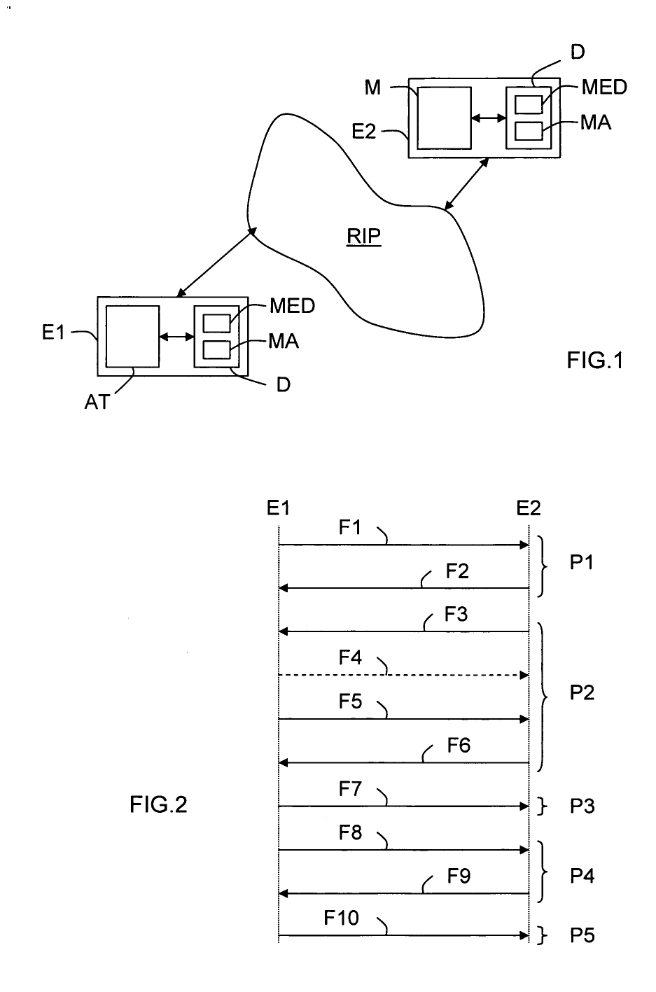

A first embodiment of the invention is described first with reference to FIGS. 1 and 2.

In this first embodiment it is considered by way of nonlimiting example that the (digital) data transmitted is facsimile type data generated by a calling server E1 of group 3 (G3) type equipped with a soft fax over IP application AT and addressed to another communication equipment E2, for example a called facsimile machine (fax) E2 also of type G3. The data to be transmitted is therefore representative of copied pages. However, the invention is not limited to these communication equipments providing a facsimile (fax) function. It relates to any communication equipment of facsimile type (in particular of super G3 or G4 type, conforming to the V34 standard, for example) or of modem type (utilizing the V8 standard, for example) capable of transmitting (digital) data via networks entailing modulation/demodulation from any source, and where applicable addressed to other equipments, for example a fixed or portable computer. Thus the invention also relates to Internet Protocol (IP) communication gateways, also known as Internet media gateways and including a facsimile modem coupled to at least one facsimile machine.

In the nonlimiting example described hereinafter with reference to FIGS. 1 and 2, the server E1 uses its soft fax over IP application AT to generate internally facsimile type digital data to be transmitted and the facsimile machine E2 receives facsimile type digital data.

Each encryption/decryption device D according to the invention is coupled either to an internal modem MD (in the case of E2) or to a soft fax over IP application AT (in the case of E1) and comprises a processor module MT that intervenes each time that a call set-up phase (P1) has been effected between its (calling or called) equipment and another equipment (called or calling) equipment.

As shown diagrammatically in FIG. 2, facsimile type data is transmitted in accordance with the ITU-T standard T.30 in five phases P1 to P5.

The first phase P1 is the call set-up phase. The calling equipment, for example the server E1, sends (arrow F1) the called equipment E2, here a facsimile machine, an optional calling tone CNG to inform it that it wishes to send it facsimile type data. The called facsimile machine E2 responds to the calling tone CNG by sending (arrow F2) the calling server E1 either a CED (called terminal identification answer tone) response signal or an amplitude and/or phase modulated ANS AM, ANS PM or ANS AM/PM type 2100 Hz response signal to inform it that it is ready to receive data.

The second phase P2 is known as the control and exchange of capacities phase (or data pretransmission procedure). It identifies the capacities that each equipment E1, E2 will use and defines the transmission conditions. The called facsimile machine E2 sends (arrow F3) the calling server E1 (for example) a message containing the DIS (Digital Identification Signal) field containing information characterizing its capacities, the CSI (Called Subscriber Identification) field containing information defining the identity of the called subscriber, and the NSF (Non-Standard Facilities) field containing in particular manufacturer information. The calling server E1 then sends (arrow F4) the call facsimile machine E2 (for example) DCS (Digital Command Signal) information that defines the configuration commands that correspond to the capacities defined by the DIS and TCS (Transmitting Subscriber Identification) information that defines the identity of the calling party. The calling server E1 then sends (arrow F5) the called facsimile machine E2 a TCF (Training Check) message (for example) that contains a T.4 modulated command to verify the line by supplying an indication as to the possibility of using a transmission channel with a given bit rate. Finally, the called facsimile machine E2 sends (arrow F6) the calling server E1 a CFR (Confirmation to Receive) reception confirmation message (for example) to report that the second phase P2 has been effected correctly and that the data can now be transmitted.

In the third phase P3 data is transmitted from the calling server E1 to the called facsimile machine E2 (arrow F7) phase under the T.4 standard.

The fourth phase P4 is the end transmission of page data and multipage signaling (or post-transmission procedure) phase. When an entire page has been sent, the calling server E1 sends (arrow F8) the called facsimile machine E2 an EOP (End Of Procedure) message (for example) to report the complete transmission of the last page and request confirmation before terminating the call. The called facsimile machine E2 then sends (arrow F9) the calling server E1 an MCF (Message Confirmation) message confirming the end of reception.

The fifth phase P5 is the end of call phase in which the calling server E1 sends (arrow F10) the called facsimile machine E2 a DCN (Disconnect) message to report that it is terminating the call.

It is important to note that the various steps described above do not constitute an exhaustive representation of all of the information exchanged between the calling and called equipments. Only the main information and main messages and/or information and messages used by the invention have been mentioned. A complete description of the five phases P1 to P5 can be found in particular in the ITU-T document “T.30—Procedure for document facsimile transmission in the general switched telephone network”, July 2003.

The processor module MT more precisely intervenes in the second phase P2, i.e. before data transmission starts (here transmission of facsimile type data).

More precisely, once the first (call set-up) phase P1 is completed (arrows F1 and F2 in FIG. 2), the processor module MT of the called equipment (here the facsimile machine E2) generates a first message to the calling equipment (here the server E1), this first message (here of type DIS, CSI and NSF—arrows F3 in FIG. 2) containing in an NSF type non-standard facilities field first data to enable the processor module MT of the calling server E1 to determine a primary encryption key K_{M} of M bits (for M=128 bits).

It is important to note that the first message (of DIS, CSI and NSF type) can be either a standard DIS, CSI and NSF message in which the first data is added to the data of the NSF field or a new dedicated DIS, CSI and NSF message.

The processor modules MT of the called facsimile machine E2 and the calling server E1 then each determine the respective primary encryption key K_{M} as a function of the first data.

It is important to note that the first data that is contained in the first message (DIS, CSI and NSF—arrow F3) may be representative of a secondary key K_{N} of N bits. In the present context the expression “first representative data” refers to data either designating a secondary key K_{N} or constituting the secondary key K_{N}. In the former case (designation), the processor module MT determines the secondary key K_{N} in a table as a function of the value of the first data and in the latter case the processor module MT has direct access to the secondary key K_{N}.

When a secondary key K_{N} is defined by the first data, each processor module MT determines the primary encryption key K_{M} as a function of that secondary key K_{N}. To this end each processor module MT uses the same selected calculation function G_{NM} including a variable equal to the secondary key K_{N} and such that G_{NM}(K_{N})=K_{M}. The function G_{NM} used for this purpose can be of any type, in particular a pseudo-random type function.

In order not to delay transmission of data significantly the number N of bits of the secondary key K_{N} is equal to 24, for example.

Once the calling server E1 has received the message containing the field NSF “augmented” with the first data, it sends the information DCS and TCS to the called facsimile machine E2 (arrow F4). The processor module MT of the calling server E1 then generates second data representative of its ability to encrypt data to be transmitted. This second data is integrated into a second message that is preferably the TCF message or in the TCS type field of another message and which the calling server E1 sends to the called facsimile machine E2 (arrow F5).

The second data that is integrated into a second message may take different forms.

For example, it may be data signifying acceptance of the encryption used (when the calling equipment E1 includes a device D of the invention, of course). In this case, if the device D of the called equipment E2 receives the second data, it knows immediately whether the calling equipment E1 includes a device D of the same type as its own. If the types are identical, the processor module MT of the device D of the called equipment E2 activates its encryption/decryption module MED in order to be ready to decrypt encrypted data (here of facsimile type) that the calling equipment E1 has to send during the third phase P3.

Alternatively, the second data may be data that is to be analyzed. In this case, the processor module MT of the device D of the called equipment E2 includes an analysis module MA for analyzing the second data contained in the TCF message (or in the TCS field) that has been received in order to determine if the device D of the calling equipment E1 is of the same type as its own.

For example, the analysis module MA analyzes the second (aptitude) data to determine if it was encrypted using the primary encryption key K_{M}. To this end, the aptitude second data may constitute a selected (alphanumeric) word known to all the analysis modules MA and encrypted using the primary encryption key K_{M}. In other words, the processor module MT of the device D of the calling equipment E1 utilizes its encryption/decryption module MED to encrypt the selected word using the primary encryption key K_{M}, the result of this encryption then constituting the second data to be integrated into the second message.

In this case, when the device D of the called equipment E2 receives the second data, it communicates it to its processor module MT in order for its encryption/decryption module MED to decrypt it using the primary encryption key K_{M}. This processor module MT then sends the result of this decryption to its analysis module MA in order for the latter to compare it to the selected word that it knows.

If the second message is of TCF type, the second data that it contains is representative of a series of symbols encrypted by the encryption/decryption module MED of the device D of the calling equipment E1 using the primary encryption key KM and under the control of its processor module MT. According to the T.30 standard, a standard TCF message comprises a series of symbols which, before modulation, take the form of a series of zeroes during a selected minimum period.

In this case, when the device D of the called equipment E2 receives the second data, it communicates it to its processor module MT in order for its encryption/decryption module MED to decrypt it using the primary encryption key K_{M}. This processor module MT then sends the result of this decryption and certain second data to its analysis module MA.

The analysis module MA effects its comparisons by drawing on the aforementioned property of the demodulated symbols (data) of the TCF messages, for example. These must take the form of a set of successive zeroes during a selected minimum period. Consequently, if Dp is the p^{th} block of TCF data received by the processor module MT, representing certain of the second data, Dkp is the result of decryption of the p^{th} block Dp by the encryption/decryption module MED and R(p) is the result of the analysis module MA comparing Dp and Dkp to the value 0 (zero), then the analysis module MA delivers a result R(p) whose value indicates a known form of encryption each time that Dkp is equal to 0 or a result R(p) whose value indicates absence of encryption each time that Dp is equal to 0, or an R(p) whose value indicates an error in all other cases.

If at the end of the TCF message the number of consecutive bits R(p) whose value indicates a known form of encryption and that were obtained in the selected period (defined by the T.30 standard) is greater than or equal to the selected number (also defined by the T.30 standard), then the processor module MT deduces that the calling equipment E1 includes a device D of the same type as its own. In this case, the processor module MT then activates its encryption/decryption module MED so that it is ready to decrypt the encrypted data (here of facsimile type) that the calling equipment E1 has to send during the third phase P3.

If at the end of the TCF message the number of consecutive bits R(p) whose value indicates absence of encryption and that were obtained in the selected period is greater than or equal to the selected number, then the processor module MT deduces that the calling equipment E1 does not include a device D of the same type as its own. In this case, the processor module MT does not activate its encryption/decryption module MED, in order for the facsimile machine E2 to receive data (here of facsimile type) sent by the calling equipment E1 during the third phase P3 in the conventional way (without encryption).

Finally, if neither of the above two situations applies, the called equipment E2 requests the calling equipment E1 to send it a new TCF message.

To make the data transmitted even more secure, the processor module MT of the devices D in the calling equipment E1 and in the called equipment E2 can vary the primary encryption key K_{M} that their encryption/decryption modules MED respectively use to encrypt and decrypt the data (here of facsimile type) during the third phase P3. These variations are effected identically and substantially simultaneously throughout the transmission of the encrypted data (i.e. throughout the third phase P3).

For example, each encryption/decryption module MED can use the same selected function to vary the primary encryption key K_{M} as a function of its preceding value: K_{M}(n)=f(K_{M}(n−1)).

In the static (no variation) situation, the function f is the identity function. In the dynamic (variation) situation, the function f can be a pseudorandom generator, for example (in which case the calling equipment E1 and the called equipment E2 have pseudorandom generators that evolve in the same manner), or any other function (known to the calling equipment E1 and the called equipment E2).

It is important to note that the encryption/decryption module MED is preferably adapted to encrypt separately the data packets to be transmitted. This enables the processor module MT to use the sequence numbers that the UDP layer assigns to the encrypted packets in order to reconstitute an ordered sequence of packets quickly after decryption, including when one or more packets are lost in transit in the network(s) RIP, here of IP type. Because these lost packets cannot be found in a network RIP, the ordered sequence is reconstructed by classifying the packets as a function of their respective sequence numbers and omitting from the sequence those that have been lost.

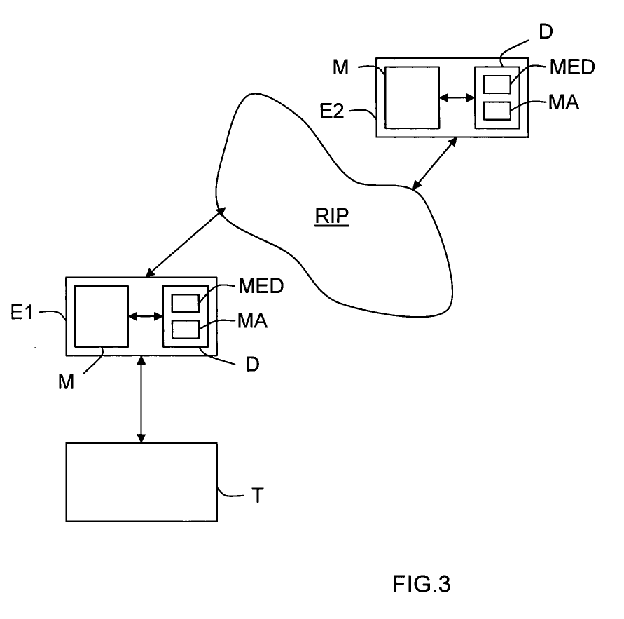

An application of the invention to the situation in which the calling equipment E1 and the called equipment E2 both have a group 3 (G3) type facsimile function is described above. However, as indicated above, the invention applies equally to the situation in which the calling equipment E1 and the called equipment E2 are modem(s) utilizing the V8 standard and/or facsimile machines(s) of the supergroup 3 (super G3) or G4 type, as shown in FIG. 3.

In the second embodiment, shown in FIG. 3, the calling equipment E1 is a modem utilizing the V8 standard and coupled to a terminal T, such as a fixed or portable computer or a server that generates internally facsimile type digital data to be transmitted, and the called equipment E2 is a super G3 type facsimile machine that can receive facsimile type digital data from the modem E1.

It is important to note that the second embodiment of the invention is not limited to transmitting facsimile type data. Two modems utilizing the V8 standard can transmit other types of data.

According to the invention, each encryption/decryption device D includes a processor module MT that intervenes each time that a call set-up phase has been effected between its (calling or called) equipment and another (called or calling) equipment, i.e. before transmission of data (here of facsimile type) begins.

More precisely, once the call set-up phase is completed, the processor module MT of the calling equipment E1 (here the modem) generates a first message to the called equipment E2 (here the facsimile machine), for example of the CM (Call Menu) type (see the V8 standard), containing in an NSF type non-standard facilities field first data to enable the processor module MT of the called facsimile machine E2 to determine a primary encryption key K_{M} of M bits (for example M=128 bits).

It is important to note that the first message (of CM type) can be either a standard CM message to the data of which the first data is added or a new dedicated CM message.

When the processor module MT of the called facsimile machine E2 receives the first message, if it is equipped with a device D it can determine the primary encryption key K_{M} as a function of the first data received and activate its encryption/decryption module MED to decrypt facsimile type encrypted data that the calling modem E1 sends it, whereas if it is not equipped with a device D, it ignores the first data it receives and waits for the calling modem E1 to send it unencrypted facsimile type data.

As in the example described above with reference to FIGS. 1 and 2, the first data contained in the first message CM may be representative of a secondary key K_{N} of N bits (for example N=24). If the secondary key K_{N} is defined by the first data, each processor module MT determines the primary encryption key K_{M} as a function of the secondary key K_{N}. To this end each processor module MT uses the same selected calculation function G_{NM} including a variable equal to the secondary key K_{N} and such that G_{NM}(K_{N})=K_{M}. Any type of function G_{NM} may be used for this purpose, and in particular a pseudorandom type function.

When the called facsimile machine E2 has received the first message CM “augmented” with the first data it sends the calling modem E1 a second message, for example of the JM (Join Menu) type (see the V8 standard). This second message JM is either of standard type if the called facsimile machine E2 does not have a device D or “augmented” by the processor module MT of the device D of the called facsimile machine E2 with second data representative of the ability of its facsimile machine E2 to encrypt/decrypt data. The second data is integrated into a second message of type JM or into a field of another message.

If there is no second data in the second message, the device D of the calling equipment E1 immediately deduces that the facsimile machine E2 is not equipped with a device D and does not activate its encryption function. The modem E1 then sends the facsimile machine E2 unencrypted facsimile type data.

If second data is present in the second message, the processor module MT of the device D of the calling equipment E1 requests its analysis module MA to analyze it. This analysis can be effected in a similar way to one of the analyses described above with reference to FIGS. 1 and 2 and as a function of the type of second data that has been received.

If the analysis indicates that the called facsimile machine E2 is able to perform decryption, the processor module MT of the device D of the calling equipment E1 determines the primary encryption key K_{M} as a function of the first data (which it previously sent to the called facsimile machine E2) and then activates its encryption/decryption module MED in order to be ready to encrypt the data (here of facsimile type) to be transmitted to the called equipment E2 using the primary encryption key K_{M}.

If the analysis indicates that the called facsimile machine E2 is not able to perform decryption, the processor module MT of the device D of the calling equipment E1 does not activate its encryption/decryption module MED. The modem E1 then sends the facsimile machine E2 unencrypted facsimile type data.

Note that, as in the first embodiment described above with reference to FIGS. 1 and 2, the transmitted data can be made more secure in this second embodiment by varying the primary encryption key K_{M} used by the encryption/decryption modules MED to encrypt and decrypt the data (here of facsimile type).

Moreover, as in the first embodiment described above with reference to FIGS. 1 and 2, the encryption/decryption module MED may be adapted to encrypt separately the data packets to be transmitted.

The first and second encryption/decryption devices D of the invention, and in particular their processor module MT, may take the form of electronic circuits, software (or electronic data processing) modules, or a combination of circuits and software.

Encryption/decryption devices for implementing the invention are described above. However, this invention also consists in a secure data transmission method that may be implemented with the aid of the first and second encryption/decryption devices D described above. The main and optional functions and subfunctions of the steps of that method being substantially identical to those of the various means constituting the first and second devices, only the steps implementing the main functions of the method of the invention are summarized hereinafter.

In the event of setting up a call between a calling equipment E1 and a called equipment E2 (for the purpose of transmitting data, for example of facsimile type), the method consists in:

transmitting from either the calling equipment E1 or the called equipment E2 to the other of those equipments a first message containing first data for determining a primary encryption key K_{M},

determining the primary encryption key K_{M} as a function of the first data in each equipment E1 and/or E2 able to encrypt/decrypt data,

transmitting from the equipment that received the first message to the equipment that sent the first message a second message containing second data representative of its ability to encrypt/decrypt data, then

if the calling equipment E1 and the called equipment E2 are able to encrypt/decrypt data, encrypting the data to be transmitted in the calling equipment E1, then transmitting the encrypted data to the called equipment E2 via the network(s) RIP, and then decrypting the encrypted data in the called equipment E2 using the primary encryption key K_{M}.

The invention has a number of advantages, including:

reduced implementation cost,

particularly easy integration,

transparency vis à vis the end users,

unique end-to-end type encryption that means it is no longer necessary to use dedicated encryption equipment each time that data in transit passes through different IP networks,

native interoperability vis a vis other equipments.

The invention is not limited to the encryption/decryption device, communication equipment and secure data transmission method embodiments described above by way of example only and encompasses all variants that the person skilled in the art might envisage that fall within the scope of the following claims.

1. A method for secure transmission of data between first and second communication equipments via at least one communication network entailing modulation/demodulation, wherein, in the event of setting up a call between said equipments with a view to transmitting data, the method consists in:
transmitting from one of said equipments to the other a first message containing in a non-standard facilities field first data for determining a primary encryption key,
then determining said primary encryption key as a function of said first data in each equipment able to encrypt/decrypt data,
transmitting from the equipment that receives said first message to the equipment that sends said first message a second message containing second data representative of its ability to encrypt/decrypt data, said second data being encrypted by means of said primary encryption key,
then, on reception of said second message in the equipment that sent the first message, attempting to decrypt the second data by means of said primary encryption key to determine if it was encrypted by means of said primary encryption key and, if so, to conclude that the equipment that sent the second message is able to encrypt/decrypt data using said primary encryption key,
then, if and only if said equipments are both able to encrypt/decrypt data, activating encryption means in the equipment having data to be transmitted and activating decryption means in the other equipment that has to receive that data, the encryption means and the decryption means using said primary encryption key.

2. A method according to claim 1, wherein said first data is representative of a secondary key and said primary encryption key is determined as a function of said secondary key.

3. A method according to claim 2, wherein said first data constitutes said secondary key.

4. A method according to claim 1, wherein said second data contained in said second message constitutes a selected series of symbols encrypted by means of said primary encryption key.

5. A method according to claim 1, wherein said primary encryption key is varied identically and substantially simultaneously in said calling equipment and said called equipment during the transmission of encrypted data.

6. A method according to claim 1, wherein, in the presence of facsimile type data and of a calling equipment and a called equipment implementing a G3 type facsimile function, in said called equipment said first data is integrated into an NSF type non-standard facilities field of a message containing fields DIS, CSI and NSF and in said calling equipment said second data is integrated into a TCF type message or into a TCS type field of another message.

7. A method according to claim 1, wherein, in the presence of a calling equipment and a called equipment of super G3 or G4 facsimile type and/or of modem type using the V8 standard, in said calling equipment said first data is integrated into a non-standard facilities field of a Call Menu type message and in said called equipment said second data is integrated into a Join Menu type message or into a field of another message.

8. A device for encrypting/decrypting data for a first communication equipment adapted to exchange data with a second communication equipment of equivalent type via at least one communication network entailing modulation/demodulation, wherein the device comprises processing means adapted to:
i) in the event of setting up a call between the first equipment, which is then referred to as the called equipment, and the second equipment, which is then referred to as the calling equipment, with a view to transmission of data from the calling equipment to the called equipment, to generate a first message to said calling equipment containing in a non-standard facilities field first data for determining a primary encryption key, and then to determine that primary encryption key as a function of said first data, and
ii) in the event of reception from said calling equipment of a second message containing second data representative of its ability to encrypt data to be transmitted followed by the reception of encrypted data, to activate decrypting means to decrypt said received encrypted data by means of said primary encryption key.

9. A device for encrypting/decrypting data for a first communication equipment adapted to exchange data with a second communication equipment of a different type via at least one communication network entailing modulation/demodulation, comprising processing means adapted to:
i) in the event of setting up a call between the first equipment, which is then referred to as the calling equipment, and the second equipment, which is then referred to as the called equipment, with a view to transmission of data from the calling equipment to the called equipment, to generate a first message to said called equipment containing in a non-standard facilities field first data for determining a primary encryption key, and
ii) in the event of reception from said called equipment of a second message containing second data representative of its ability to decrypt data, determine said primary encryption key as a function of said first data and then activate encrypting means to encrypt data to be transmitted to said called equipment by means of said primary encryption key.

10. A device according to claim 8, wherein said processing means are adapted to generate first messages containing in a non-standard facilities field first data representative of a selected secondary key and to determine said primary encryption key as a function of said selected secondary key.

11. A device according to claim 10, wherein said first data constitutes said secondary key.

12. A device according to claim 8, wherein said processing means are adapted to generate second messages containing second data encrypted by means of said primary encryption key.

13. A device according to claim 8,
wherein said processing means comprise analysis means adapted, in the event of reception of a second message, to analyze the second (aptitude) data that it contains to determine if it was encrypted by means of said primary encryption key.

14. A device according to claim 13, wherein said processing means are adapted in the event of reception of a second message to decrypt said second data by means of said primary encryption key and said analysis means are adapted to determine if the decryption result corresponds to encryption by means of said primary encryption key in order in the event of a match to authorize said processing means to encrypt data to be transmitted or to decrypt transmitted encrypted data.

15. A device according to claim 13, wherein said processing means are adapted to integrate said second data constituting a selected series of symbols encrypted by means of said primary encryption key into said second message.

16. A device according to claim 8, wherein said processing means are adapted to vary said primary encryption key during the transmission of encrypted data.

17. A device according to claim 8, wherein said processor means are adapted in the presence of facsimile type data to integrate said first data into a non-standard facilities field of NSF type of a message containing fields DIS, CSI and NSF and said second data into a message of TCF type or into a field of TCS type of another message.

18. A device according to claim 9, wherein said processor means are adapted in the presence of facsimile type data to integrate said first data into a non-standard facilities field of a Call Menu type message and said second data into a non-standard facilities field of a Join Menu type message or into a field of another message.

19. Communication equipment for an Internet protocol communication network, comprising an encryption/decryption device according to claim 8.
